(19) United States
(12) Patent Application Publication
(10) Pub. No.: US 2024/0265719 A1
(43) Pub. Date: Aug. 8, 2024

(54) OCR OF TEXT OVERLAPPING SCENES THROUGH TEXT GRAPH STRUCTURING

(71) Applicant: International Business Machines Corporation, Armonk, NY (US)

(72) Inventors: Yuan Yuan DING, Shanghai (CN); Zhong Fang YUAN, Xi'an (CN); Tong LIU, Xi'an (CN); Si Tong ZHAO, Beijing (CN); Yi Chen ZHONG, Shanghai (CN)

(21) Appl. No.: 18/165,125

(22) Filed: Feb. 6, 2023

(51) Int. Cl. G06V 30/19; G06V 10/82; G06V 30/148; G06V 30/414

(52) U.S. Cl. CPC G06V 30/1914; G06V 10/82; G06V 30/148; G06V 30/19007; G06V 30/414

(57) ABSTRACT

Embodiments of the present disclosure provide systems and methods for implementing enhanced Optical Character Recognition (OCR) of text overlapping scenes through text graph structuring. Text graph structuring is performed to provide a graph data structure for each data character or letter of multiple letters and a library of graph templates from graph structured data of each of the multiple letters. Text graph structuring is performed to convert visual content of an identified overlapping text image region to an overlapping text topology graph. The overlapping text topology graph is split into multiple subgraphs using the graph template library to match recognizable letters in the overlapping text.

### BACKGROUND

The present invention relates to computer systems, and more specifically, to Optical Character Recognition (OCR) of text overlapping scenes through text graph structuring.

In OCR systems, the recognition of text overlapping areas typically presents a significant challenge. This challenge arises mainly due to the phenomenon of overlapping text in the region to be recognized, which makes it difficult for OCR recognition algorithms to distinguish the text in the region to be recognized. Traditional methods usually divide the text in the overlapping region into two types, i.e., foreground and background. After distinguishing the data types, the traditional method works to remove the background area (using semantic segmentation and other methods), leaving only the foreground to provide the final recognition. Due to limitations of current technology, even noise reduction methods such as background removal fail to eliminate the problem of text overlap. The recognition rate of the overlapping part remains at a low level. Further loss of background text information can cause final recognition results with information loss.

### SUMMARY

Embodiments of the present disclosure provide systems and methods for implementing enhanced Optical Character Recognition (OCR) of text overlapping scenes through text graph structuring.

One disclosed non-limiting method implements Optical Character Recognition (OCR) of text overlapping scenes through text graph structuring. A disclosed method can include processing a letter into graph-structured data by capturing an endpoint, turning point and intersection in letters as nodes and the lines between nodes as edges in the graph data structure. A library of graph templates is constructed based on the graph structured data of each of the multiple letters. An image region with overlapping text is identified in an image document and text graph structuring is performed to convert visual content of the overlapping text image region to an overlapping text topology graph. The overlapping text topology graph is split into multiple subgraphs using the graph template library to match recognizable letters.

Other disclosed embodiments include a computer system and computer program product for implementing Optical Character Recognition (OCR) of text overlapping scenes through text graph structuring implementing features of the above-disclosed method.

### BRIEF DESCRIPTION OF THE DRAWINGS

FIG. 1 is a block diagram of an example computer environment for use in conjunction with one or more disclosed embodiments for implementing Optical Character Recognition (OCR) of text overlapping scenes through text graph structuring;

FIG. 2 is a block diagram of an example system for implementing Optical Character Recognition of text overlapping scenes through text graph structuring of one or more disclosed embodiments;

FIG. 3A is a flow chart illustrating an example method for implementing Optical Character Recognition of text overlapping scenes through text graph structuring of one or more disclosed embodiments;

FIG. 3B schematically illustrates example OCR operations of processing letters as a graph structured data and processing text overlapping scenes of one or more disclosed embodiments;

FIG. 4 schematically illustrates example template graph preparation operations of one or more disclosed embodiments;

FIG. 5 schematically illustrates example text overlapping area detection and joint point detection operations of one or more disclosed embodiments;

FIG. 6 schematically illustrates example operations of creation and initialization of topology map of one or more disclosed embodiments;

FIG. 7 schematically illustrates example operations to convert images in visual form of overlapping text regions to topological graphs with graph structure and to update vectors on each graph node of one or more disclosed embodiments; and

FIG. 8 schematically illustrates example operations of subgraph segmentation based on template graph matching of one or more disclosed embodiments.

### DETAILED DESCRIPTION

Embodiments of the present disclosure provide systems and methods for implementing enhanced Optical Character Recognition (OCR) of text overlapping scenes through text graph structuring. In one embodiment, text graph structuring is performed to provide a graph data structure for each data character or letter, such as letters, numbers, and other selected symbols. For example, a respective graph data structure can be produced for a set of 26 English capital letters i.e., A-Z, a set of numerals, i.e., 0-9, and selected symbols. For example, the system uses a joint detection annotation method to annotate each letter graph data structure with joint points. The annotation method classifies each of the joint points into one of three joint types including endpoints, intersections, and turning points. The endpoints, turning points, and intersections of the letter are treated as nodes in the graph data structure, and the lines between nodes as edges in the graph data structure template. After joint labeling of the letter's nodes, the OCR system can convert the letter patterns into a letter topological diagram in the form of point-edge-point. The system collects the letter topology diagrams to provide a graph template library of letter diagram templates. Constructing a graph template for the letter optionally includes encoding each node in the graph data structure of the letter using a graph neural network (GNN.). A library of graph templates can include for example a respective encoded-node graph data structure for each of the 26 English capital letters A-Z, numerals 0-9, and any selected, such as commonly used symbols.

In one embodiment, the OCR system identifies a region with overlapping text and can extract the overlapping text areas from an image page. The OCR system can detect all the joint points or nodes of the content in the overlapping text areas and encodes each of detected nodes. The OCR system converts the overlapping text in visual form to topology graphs with graph structure with the detected nodes in the text overlap region recognized as nodes and lines between the nodes as edges in the topology map. A small range extending around the node with the node as the center is processed, and the visual features are collected in this range. Each of the nodes is encoded, converting the node into an initialization vector. For example, ResNet can be used as the encoder to convert each node into a vector form as the initialization vector of the respective nodes.

The vectors on each graph node can be updated, for example by unsupervised encoding of the transformations of nodes in a graph. For example, the node vectors in the topology graph are updated, so that each node in the topology graph represents the information of features of the larger feeling field and the features of the graph topology structure. For example, a Graph Transformation Equivariant Representations (GraphTER) network can be used to update the vectors on each graph node. The GraphTER network enables a method for learning GraphTER by unsupervised encoding of the transformations of nodes in a graph. This updated topology graph introduces information relating to neighboring nodes and the topology of the graph topology structure.

Based on the updated topology graph, Node classification can be used to label each node and split the overlapping topology graph into multiple independent subgraphs, and after the splitting, each subgraph can be matched to an independent letter in the template library. In this way, the overlapping text regions can be split into independent letters. The training data of the classification algorithm can be generated automatically from the data in the graph template library or by manual labeling.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as an OCR Control Component 182, Letter Graph Structured Data 184, and a Graph Template Library 186 of the Letter Graph Structured Data at block 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

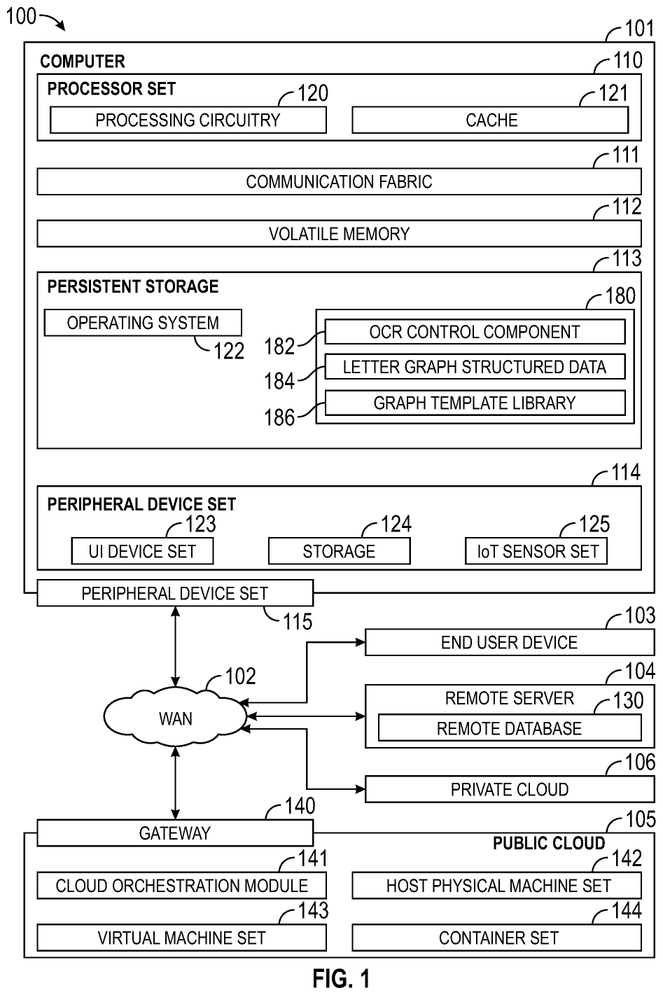

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Embodiments of the present disclosure enable enhanced optical character recognition of text overlapping scenes. In accordance with disclosed embodiments, a computer-implemented non-limiting method implements enhanced optical character recognition of text overlapping scenes through text graph structuring. Text graph structuring of disclosed embodiments enables optimizing optical character recognition of text overlapping scenes. A disclosed method can include processing a letter (or character) as graph structured data by capturing joint points including one or more endpoints, turning points and intersections in letters as nodes and the lines between nodes as edges in the graph data structure. The method can convert the letter patterns into a topological diagram in the form of point-edge-point. The method collects the topology diagrams to provide a graph template library of diagram templates. Constructing a graph template for the letter can include encoding each node in the graph data structure of the letter using a graph neural network (GNN.).

In one embodiment, a non-limiting method implements enhanced optical character recognition of text overlapping scenes through text graph structuring. A disclosed method can include identifying a region with overlapping text and extracting the overlapping text areas from an image document. The disclosed method can detect all the joint points or nodes of the content in the overlapping text areas and encodes each of detected nodes. The disclosed method converts the overlapping text in visual form to overlapping text topology graph. In the overlapping text topology graph, the detected joints in the text overlap region are recognized as nodes and lines between the nodes as edges in the topology graph. Each of the nodes can be encoded, converting the node into an initialization vector. The vectors on each graph node can be updated so that each node in the topology graph represents the information of features of the larger feeling field and features of the graph topology structure. This vector update introduces information about neighboring nodes and the topology of the graph. Based on the updated topology graph, the OCR system can split the overlapping text topology graph into multiple independent subgraphs and the multiple independent subgraphs can be matched to a recognizable characters (i.e., independent letters) using the letter graph template library.

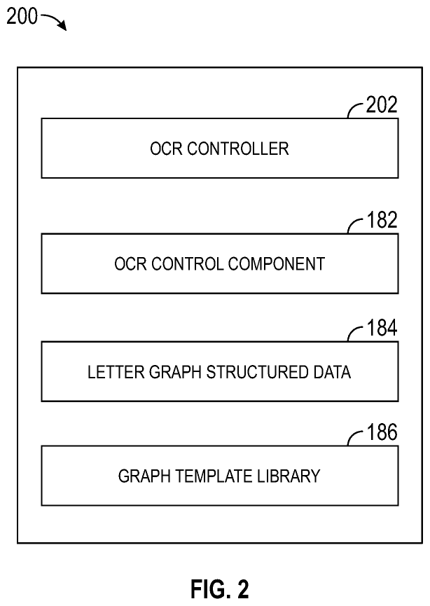

FIG. 2 illustrates an example system 200 for implementing enhanced optical character recognition of text overlapping scenes through text graph structuring of one or more disclosed embodiments. System 200 can be used in conjunction with the computer 101 and cloud environment of the computing environment 100 of FIG. 1 for implementing optimized optical character recognition of text overlapping scenes through text graph structuring of one or more disclosed embodiments.

System 200 includes an OCR Controller 202 for example used together with the computer 101 and the OCR Control Component 182, the Letter Graph-Structured Data 184, and Graph Template Library 186 of the Letter Graph-Structured Data for implementing enhanced optical character recognition of text overlapping scenes through text graph structuring of one or more disclosed embodiments.

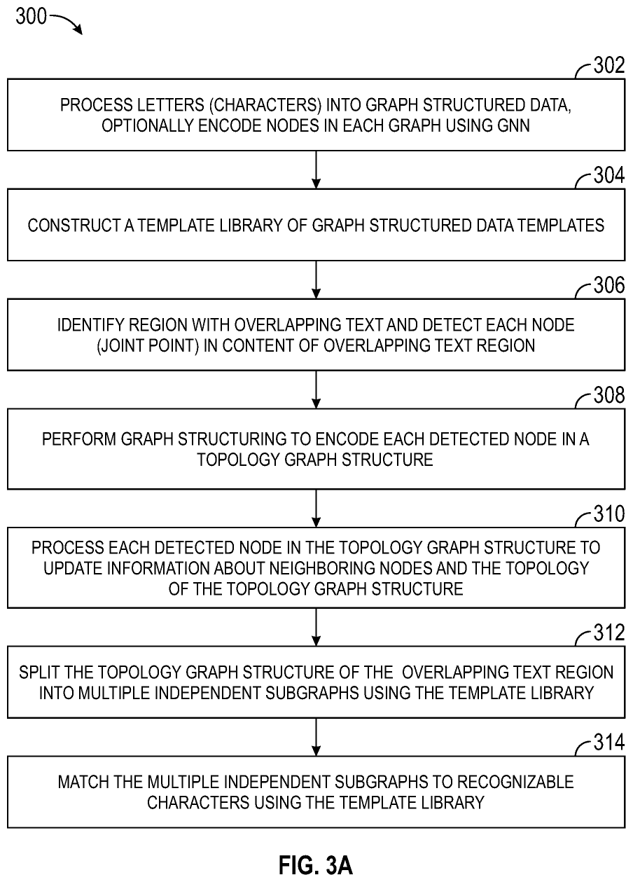

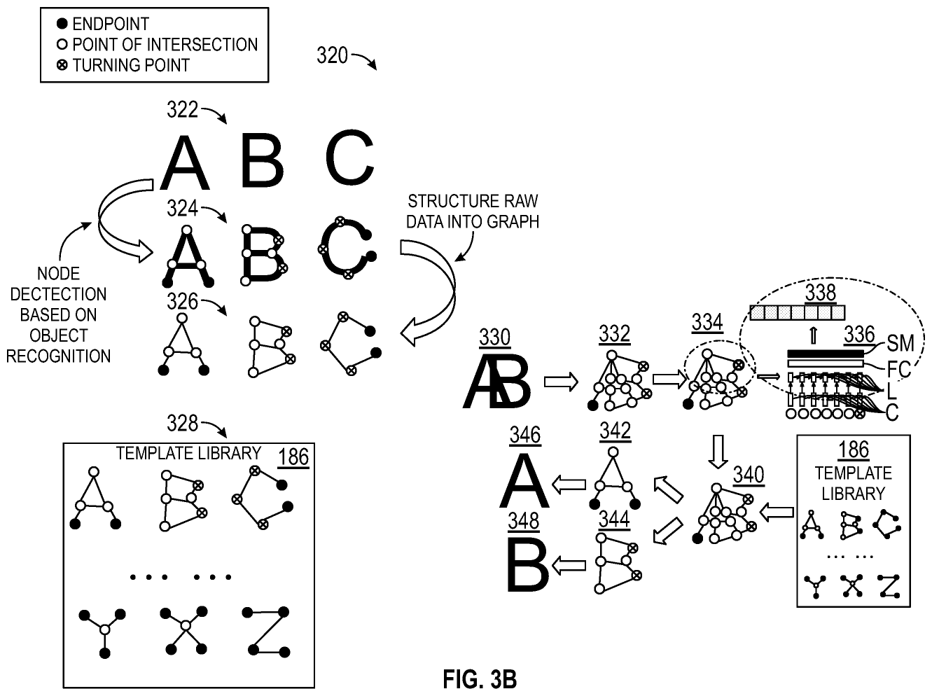

System 200 implements an example optical character recognition method 300 shown in FIG. 3A and example OCR functional operations and illustrations 320 shown in FIG. 3B of one or more disclosed embodiments to provide enhanced optical character recognition of text overlapping scenes through text graph structuring.

Referring to FIGS. 3A and 3B, various aspects and features of one or more disclosed embodiments are illustrated and described to provide illustrative examples and are not restrictive limitations. For the purposes of explanation, characters being processed for OCR are referred to as a letter or letters, while the characters include multiple character types including letters, numbers, and various selected symbols.

FIG. 3A illustrates the example optical character recognition method 300 of processing letters as a graph structured data and processing text overlapping scenes of one or more disclosed embodiments. FIG. 3B schematically illustrates example OCR functional operations and illustrations 320 of processing letters as a graph structured data and processing text overlapping scenes of one or more disclosed embodiments

In FIG. 3A at block 302, System 200 processes letters into graph structured data performing text graph structuring for OCR. System 200 captures and encodes the nodes in the graph structured data for each of the letters, for example optionally encodes the nodes using a GNN. In one disclosed embodiment, System 200 performs text graph structuring to provide a graph data structure for each of multiple letters, text characters, can include letters, numbers, and other selected symbols. A respective graph data structure can be produced for example, for 26 English capital letters A-Z, numerals 0-9, and selected symbols.

At block 302, for example, System 200 can use a joint detection annotation method to annotate each letter graph data structure with joint points. In one embodiment, the annotation method classifies each of the joint points into one of three joint types including endpoints, intersections and turning points. The endpoints, turning points, and intersections of the letter are treated as nodes in the graph data structure, and the lines between nodes as edges in the graph data structure.

Referring to FIG. 3B, System 200 receives an image of representative letters A, B, C to be processed as illustrated at 322. The representative letters A, B, C are processed for example using Node Detection Based On Object Recognition as indicated by the associated labeled arrow. As illustrated at 324, the illustrated processed letters A, B, C include multiple captured nodes or detected joint points representing nodes classified as endpoint, turning point and intersection. As illustrated at 326, System 200 transforms the structure raw data into graph data structures for the processed letters A, B, C with lines between the captured nodes providing edges in each respective graph data structure template.

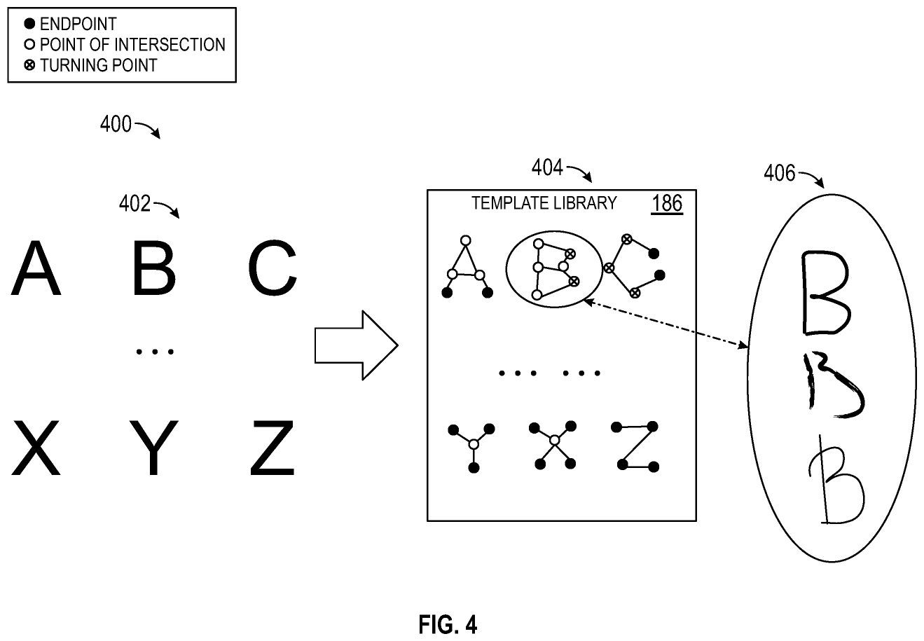

At block 304 and as illustrated at 328 in FIG. 3B, System 200 constructs a template library 186 of graph structured data templates with encoded nodes in each graph. The template library 186 includes a respective graph structured data template for various text characters, such as 26 English capital letters A-Z, numerals 0-9, and selected symbols. It should be understood that System 200 can provide graph structured data templates various symbols, other fonts, and other languages. For example, System 200 can provide graph structured data templates for selected languages, such as Chinese, Japanese, and Korean and store the graph structured data templates in the graph template library 186 in accordance with the disclosed embodiments. FIG. 4 described below schematically illustrates an example construction of the graph template library 186.

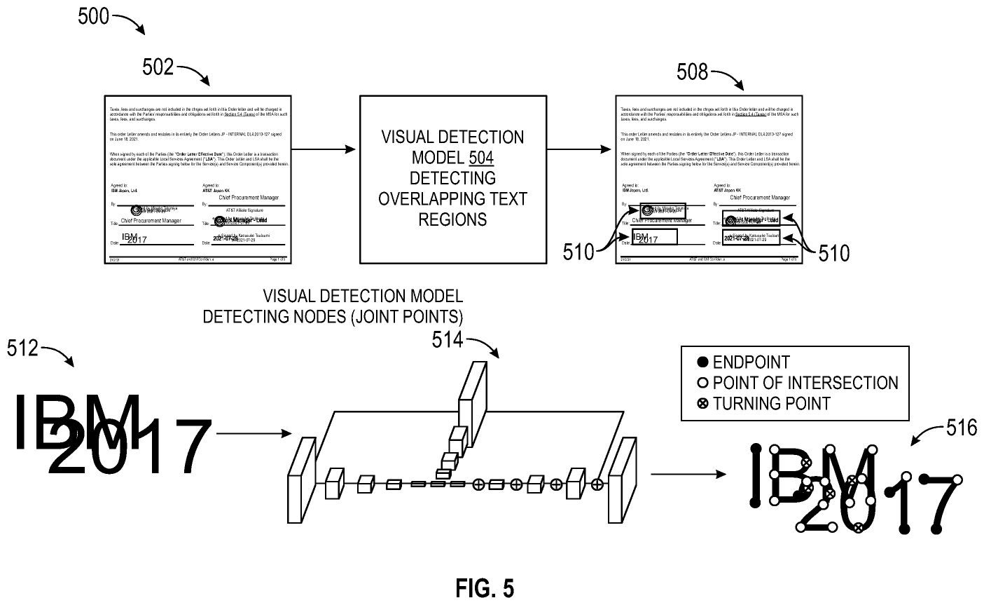

At block 306 System 200 receives an OCR document image and identifies one or more regions with overlapping text and detects nodes or joint points in the image content of the overlapping text region. As illustrated at 330 in FIG. 3B, an example image content of the overlapping text region includes an example overlapping text A and B. FIG. 5 described below schematically illustrates further example text overlapping area detection and joint point detection operations of one or more disclosed embodiments.

System 200 can encode each of the detected nodes of the overlapping text region, such as performed to construct the graph template library 186. System 200 can encode each of the detected nodes, converting each detected node into an initialization vector. The initialization node vectors in the topology graph can be updated, so that each node in the topology graph represents the information of features of the larger feeling field (i.e., information about neighboring nodes) and features of the graph topology structure.

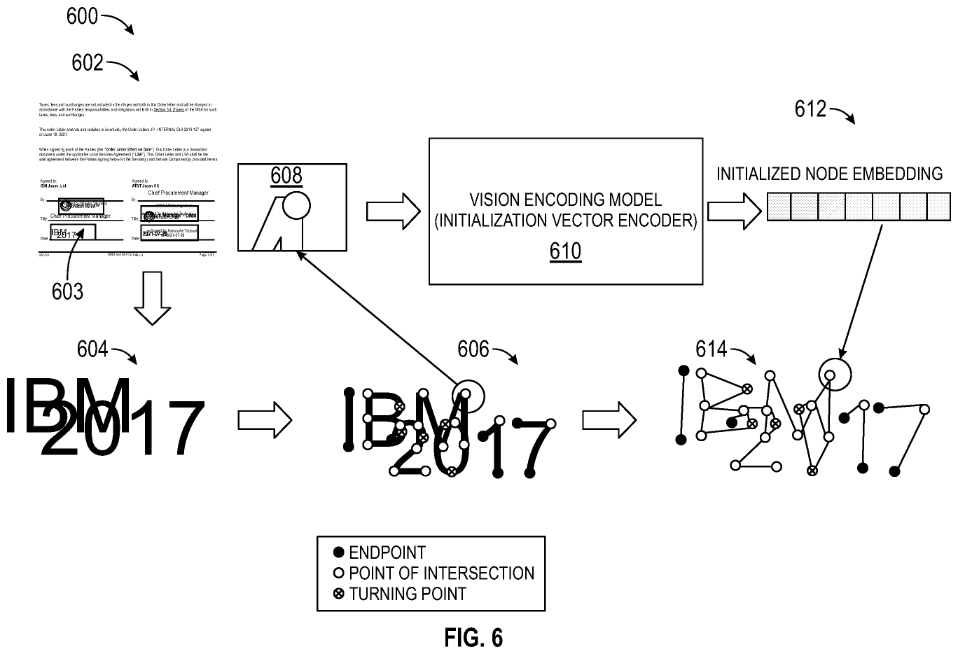

At block 308 System 200 performs graph structuring to encode each detected node in a topology graph structure into a vector form with an initialization vector of the nodes. The overlapping text region contents are converted from visual form images into topological graphs through text graph structuring with initial vectors are attached to each node. As illustrated at 332 and 334 in FIG. 3B, an example processed image content includes multiple detected nodes in the illustrated topology graph structure. As illustrated at 334 in FIG. 3B, an example encircled group of the multiple detected nodes in the topology graph structure are shown. The multiple detected nodes in the topology graph structure can be encoded with initial vectors for example by encoding the nodes using a GNN such as illustrated at 336. An encoded initial vector for one example node is illustrated at 338. FIG. 6 described below schematically illustrates example operations 600 of creation and initialization of topology graph structure.

At block 310 System 200 processes each detected node in a topology graph structure to update the nodes with information about neighboring nodes and the topology of the topology graph structure. For example, the vectors on each graph node at 334 can be updated, for example by unsupervised encoding of the transformations of nodes in a graph. A

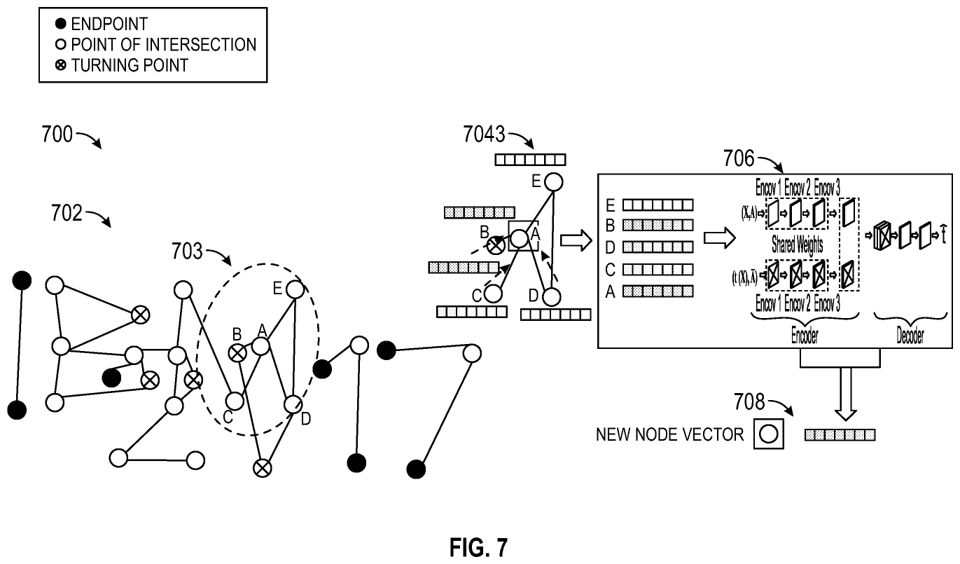

GraphTER network can be used to update the vectors on each graph node, as further illustrated and described below with respect to FIG. 7.

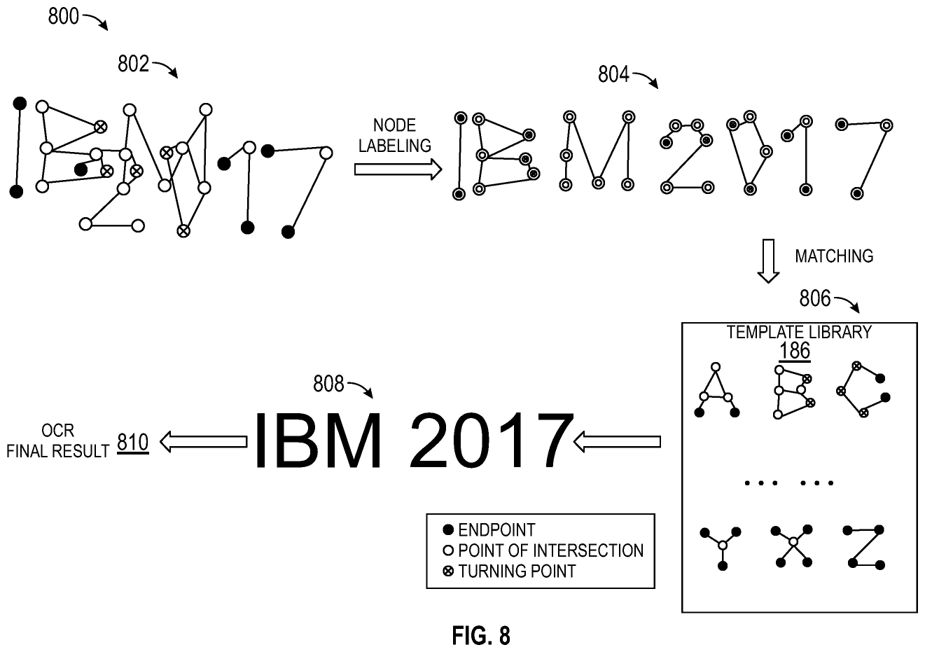

Based on the updated topology graph, in one embodiment, system 200 uses node classification to label each node and split the overlapping topology graph into multiple independent subgraphs, and after the splitting, each subgraph can be matched to an independent letter in the template library 186. In this way, the overlapping text regions can be split into independent letters. For example, the training data of the classification algorithm can be generated automatically from the data in the template library or by manual labeling. FIG. 8 described below, schematically illustrates example operations 800 of subgraph segmentation based on template graph matching.

At block 312 System 200 splits the topology graph structure of the overlapping text region into multiple independent subgraphs. For example, as illustrated at 340 in FIG. 3B, an example illustrated topology graph structure including updated node vectors is processed and split into subgraphs using the template library 186. As shown if FIG. 3B, the topology graph structure is split into two subgraphs, illustrated at 342 and 344 using the template library 186.

At block 314 System 200 can match multiple independent subgraphs to recognizable letters or characters using the template library 186. In FIG. 3B, the subgraphs 342 and 344 match the recognizable letters or characters A and B illustrated at 346 and 348.

FIG. 4 schematically illustrates example OCR operations 400 of template graph construction with a graph structure of capital letters A, B, C and Y, X, Z, as shown. At 402, an OCR image of representative capital letters A, B, C and Y, X, Z is processed to provide the Graph Template Library 186 at 404. As shown at 404, each graph template of letter graph structured data includes nodes comprising endpoints, points of intersection, and turning points. Each graph template of letter graph structured data includes edges defined by lines between the nodes. Various characters, languages, and symbols can be implemented by a constructed Graph Template Library 186 of disclosed embodiments.

The topological diagrams converted to these letters, such as illustrated at 404 have strong conceptual abstraction. For example, the topological diagrams of handwritten B, such as illustrated at 406, and topological diagram of graph structure template B at 404 illustrated in the template library 186 can be very similar and for example, can be easily considered as the same structure when matching diagram structures.

In one embodiment, System 200 identifies a region with overlapping text and can extract the overlapping text areas from an image page. The OCR system 200 can detect all the joint points or nodes of the content in the overlapping text areas and encodes each of detected nodes. The OCR system converts the overlapping text in visual image form to topology graphs with a graph structure including the detected joints in the text overlap region recognized as nodes and lines between the nodes as edges in the topology map, such as illustrated in FIG. 5.

FIG. 5 schematically illustrates example operations 500 for overlapping area and joint point detection of one or more disclosed embodiments. System 200 receives an input document image, such as the illustrated input OCR document image 502 and processes the input OCR image document to identify overlapping text regions, for example with a visual detection module 504 to detect text overlapping text regions.

System 200 for example trains two computer visual detection models, such as a computer-implemented visual detection model 504 to detect the text overlapping region and a computer-implemented visual detection model 514 to detect the joint points, respectively. For example, the text overlap detection model 504 can be based on YOLO (You Only Live Once) Real Time Object Detection or YOLOv4, a single stage machine learning object detection model that can be used to detect the position and type of an object. For example, the joint detection model 514 can be based on an Hourglass module, which is an image block that can be used to detect joint points or nodes in the content of the identified overlapping text areas, as illustrated in FIG. 5. For example, after training, System 200 includes the two models, visual detection model 504 and visual detection model 514, where visual detection model 504 can extract the overlapping text areas from the input document image, and visual detection model 514 can detect all the nodes or joint points of the content in the overlapping text areas detected by visual detection model 504.

System 200 can use various available computer vision modules to implement the computer-implemented visual detection model 504, such as the YOLOv4 object detection model, to provide effective and efficient object detection of overlapping text regions, such as illustrated at 508. For example, the YOLOv4 object detection model 504 can provide a series of computer vision techniques to produce detected overlapping text areas in an output document image, such as shown an illustrated output document image 508. The illustrated output document image 508 includes multiple identified overlapping text regions 510 indicated in blocks inside the output document image 508.

System 200 processes example overlapping text of IBM and 2017 shown at 512, for example using the visual detection module 514 such as a computer vision node detection module of a type of Hourglass module schematically illustrated at 514. The Hourglass module 514 is an image block module that is often used for limb and pose estimation tasks for a detected object to capture information at a selected scale. Visual joint detection module 514, such as Hourglass module 514 can provide the processed overlapping text of IBM and 2017 such as illustrated at 516 with multiple detected joint points including endpoints, points of intersection, and turning points.

FIG. 6 schematically illustrates example operations 600 of creation and initialization of an example topology map of one or more disclosed embodiments. As illustrated in FIG. 6 in one embodiment, System 200 converts the overlapping text in visual form to topology graphs with graph structure with the detected joint points or nodes in the text overlapping region recognized as nodes and lines between the nodes as edges in the topology map.

As shown at 602, System 200 receives a document image with one illustrated OCR overlapping text image 603 to be processed into a topology graph structure. The illustrated OCR overlapping text image 603 is one of the multiple identified overlapping text regions 510 of the output document image 508 in FIG. 5. At block 604, System 200 processes the illustrated extracted overlapping text image 603 of IBM and 2017 to provide an annotated overlapping text with multiple detected joint points, such as illustrated at 606.

At 606, the annotated overlapping text IBM and 2017 is shown with multiple detected joint points including one representative node 608, which is applied to a vision encoding model 610, such as an initialization vector encoder using a node encoding algorithm for encoding the node 608 with an initialization vector. For example, a small node range extending around the node with the node as the center illustrated at 608 is processed, and the visual features are collected in this range. The node at 608 is encoded with the vision encoding model or initialization vector encoder 610 by converting the node 608 into an initialization vector for initialized node embedding illustrated at 612. For example, a Residual Network (ResNet) encoder, which is an artificial neural network (ANN) can implement vision encoding model 610 and can be used to convert node 608 into a vector form as the initialization vector of the respective nodes.

At 612, initialize node embedding is represented for the encoded node 608. For example, initial vectors are attached to each node in the illustrated overlapping text region 603 converting each node into vector form using as the vision encoding model, such as the residual neural network (ResNet) to provide the overlapping text topology map as illustrated at 614. The original text overlap region 603 is converted into the illustrated topological map structure at 614 including detected nodes and lines between the encoded nodes as edges in the topological map.

FIG. 7 schematically illustrates example operations 700 to convert images in visual form of overlapping text regions to topological graphs with graph structure and to update vectors on each graph node of one or more disclosed embodiments. The vectors on each graph node can be updated, for example by unsupervised encoding of the transformations of nodes in a graph. For example, the node vectors in the topology graph are updated, so that each node in the topology graph represents the information of features of the larger feeling field and the features of the graph topology structure. For example, a GraphTER network can be used to update the vectors on each graph node. GraphTER provides a method for learning GraphTER by unsupervised encoding of the transformations of nodes in a graph. This update introduces information for neighboring nodes and the topology of the graph.

In FIG. 7 at operation 702, an illustrated topological graph includes an example subgraph 703 shown within a dashed box that includes a plurality of nodes A-E. At operation 704, System 200 provides initialization vectors represented by associated rectangles with the respective nodes A-E in the subgraph 703 to be updated. At vector update operation 706 System 200 can be implemented by an illustrated GraphTER network 706 to perform vector updates on the initialization vectors of the nodes A-E in the subgraph 703. At operation 708, System 200 provides for each the nodes A-E, an updated node vector with one shown for node A labeled NEW NODE VECTOR, which not only represents the information of the node itself, but also introduces its neighbor node information and graph topology information.

To perform vector updates on the initialization vectors of the nodes A-E, the GraphTER network 706 updates the vectors on each graph node A-E. GraphTER network 706 implements a method for learning Graph Transformation Equivariant Representations (GraphTER) by unsupervised encoding of the transformations of nodes, such as in the illustrated graph 702. At block 708, the vector update introduces information about neighboring nodes and information to learn the topology of the graph.

FIG. 8 schematically illustrates example operations 800 of subgraph segmentation based on template graph matching of one or more disclosed embodiments. In FIG. 8 at operation 802, the updated node vectors in the topology graph are used, each node in the topology graph includes the information features of the larger feeling field and the features of the graph topology structure. As indicated by the arrow labeled Node Labeling, at operation 804 based on the updated topology graph, Node classification can be used to label each node and split the overlapping topology graph into multiple independent subgraphs. The training data of the classification algorithm can be generated automatically from the data in the template library 186 or by manual labeling. At 804, the illustrated multiple independent subgraphs respectively represent IBM 2017. As indicated by the arrow labeled Matching, at operation 806 after the splitting, each subgraph can be matched to an independent letter in the template library 186. In this way, the overlapping text regions can be split into independent recognizable letters, optimizing the OCR recognition of overlapping text as illustrated at 808, to provide the OCR final result 810.

In brief, methods of disclosed embodiments use topological information of an overlapping data graph structure to optimize OCR overlapping text recognition. One or more disclosed algorithms can be easily migrated to different fonts, languages and symbols, enabling wide applicability of the disclosed OCR overlapping text recognition. System 200 can map multiple different kinds of fonts to standard fonts. System 200 can improve the accuracy of OCR overlapping text recognition by a significant extent.

While the foregoing is directed to embodiments of the present invention, other and further embodiments of the invention may be devised without departing from the basic scope thereof, and the scope thereof is determined by the claims that follow.

What is claimed is:

1. A method comprising:
converting, as part of an Optical Character Recognition (OCR) process, each letter of multiple letters into graph structured data, the graph structured data comprising detected nodes and lines between the detected nodes;
constructing a library of graph templates from the graph structured data of each letter of the multiple letters;
identifying an image region of a document image with overlapping text;
performing text graph structuring to convert visual content of the overlapping text image region to an overlapping text topology graph; and
splitting the overlapping text topology graph into multiple subgraphs using the graph template library to match recognizable letters.

2. The method of claim 1, wherein converting the letter image into the graph structured data for each letter of the multiple letters further comprises:
detecting joint points comprising an endpoint, a turning point, and an intersection point representing the detected nodes in the graph structured data.

3. The method of claim 1, wherein converting the letter image into the graph structured data for each letter of the multiple letters further comprises:
encoding each node in the graph structured data of a letter using a graph neural network (GNN.)

4. The method of claim 1, wherein converting the letter image into the graph structured data for each letter of the multiple letters further comprises:
converting the graph structured data of a letter into a topology diagram of a point-edge-point topology diagram.

5. The method of claim 1, wherein identifying the image region with the overlapping text of the image document further comprises extracting the overlapping text region from the image document, and detecting the nodes in the image content of extracted overlapping text region.

6. The method of claim 1, wherein performing text graph structuring to convert the visual content of the overlapping text image region to the overlapping text topology graph further comprises identifying detected joint points of the visual content as the nodes in the overlapping text topology graph and the lines between the nodes as edges in the overlapping text topology graph.

7. The method of claim 1, wherein performing text graph structuring to convert the visual content of the overlapping text image region further comprises encoding the nodes in the overlapping text topology graph to convert each node into an initialization vector and performing vector updates on the nodes to provide an updated node vector including neighboring nodes information and graph topology information.

8. The method of claim 1, wherein performing text graph structuring to convert the visual content of the overlapping text image region further comprises labeling each node using node classification, updating and attaching vectors to each node in the in the overlapping text topology graph.

9. The method of claim 1, wherein splitting the overlapping text topology graph into multiple independent subgraphs further comprises using a classification algorithm to split the overlapping region into recognizable characters.

10. The method of claim 1, wherein splitting the overlapping text topology graph into multiple independent subgraphs further comprises using topological information of the overlapping text topology graph and matching recognizable letters in the graph template library.

11. A system, comprising:
a processor; and
a memory, wherein the memory includes a computer program product configured to perform operations for implementing Optical Character Recognition (OCR) of text overlapping scenes, the operations comprising:
converting, as part of an Optical Character Recognition (OCR) process, each letter of multiple letters into graph structured data, the graph structured data comprising detected nodes and lines between the detected nodes;
constructing a library of graph templates from the graph structured data of each letter of the multiple letters;
identifying an image region of a document image with overlapping text;
performing text graph structuring to convert visual content of the overlapping text image region to an overlapping text topology graph; and
splitting the overlapping text topology graph into multiple subgraphs using the graph template library to match recognizable letters.

12. The system of claim 11, wherein converting the letter image into the graph structured data for each letter of the multiple letters further comprises:
detecting joint points comprising an endpoint, a turning point, and an intersection point representing the detected nodes in the graph structured data.

13. The system of claim 11, wherein converting the letter image into the graph structured data for each letter of the multiple letters further comprises:
encoding each node in the graph structured data of the letter using a graph neural network (GNN.)

14. The system of claim 11, wherein converting the letter image into the graph structured data for each letter of the multiple letters further comprises:
converting the graph structured data of the letter into a topology diagram of a point-edge-point topology diagram.

15. The system of claim 11, wherein performing text graph structuring to convert the visual content of the overlapping text image region further comprises encoding nodes in the overlapping text topology graph to convert each node into an initialization vector and performing vector updates on the nodes to provide an updated node vector including neighboring nodes information and graph topology information.

16. A computer program product for implementing Optical Character Recognition (OCR) of text overlapping scenes, the computer program product comprising:
a computer-readable storage medium having computer-readable program code embodied therewith, the computer-readable program code executable by one or more computer processors to perform an operation comprising:
converting, as part of an Optical Character Recognition (OCR) process, each letter of multiple letters into graph structured data, the graph structured data comprising detected nodes and lines between the detected nodes;
constructing a library of graph templates from the graph structured data of each letter of the multiple letters;
identifying an image region of a document image with overlapping text;
performing text graph structuring to convert visual content of the overlapping text image region to an overlapping text topology graph; and
splitting the overlapping text topology graph into multiple subgraphs using the graph template library to match recognizable letters.

17. The computer program product of claim 16, wherein converting the letter image into the graph structured data for each letter of the multiple letters further comprises:
detecting joint points comprising an endpoint, a turning point, and an intersection point representing the detected nodes in the graph structured data.

18. The computer program product of claim 16, wherein converting the letter image into the graph structured data for each letter of the multiple letters further comprises:
encoding each node in the graph structured data of the letter using a graph neural network (GNN.)

19. The computer program product of claim 16, wherein converting the letter image into the graph structured data for each letter of the multiple letters further comprises:
converting the graph structured data of the letter into a topology diagram of a point-edge-point topology diagram.

20. The computer program product of claim 16, wherein performing text graph structuring to convert the visual content of the overlapping text image region further comprises encoding nodes in the overlapping text topology graph to convert each node into an initialization vector and performing vector updates on the nodes to provide an updated node vector including neighboring nodes information and graph topology information.
